(19) United States
(12) Patent Application Publication
(10) Pub. No.: US 2026/0350425 A1
(43) Pub. Date: Nov. 5, 2026

(54) Information Processing System and Information Processing Method

(71) Applicant: LINKED IDEAL LLC., Tokyo (JP)

(72) Inventor: Makoto KUBODERA, Tokyo (JP)

(21) Appl. No.: 19/480,059

(22) PCT Filed: Jul. 5, 2024
(86) PCT No.: PCT/JP2024/024476

§ 371 Date: Oct. 30, 2025

(30) Foreign Application Priority Data
Aug. 7, 2023 (JP) 2023-128856

(51) Int. Cl. G06N 5/022; G06N 10/40; G06N 10/60

(52) U.S. Cl. CPC G06N 5/022; G06N 10/40; G06N 10/60

(57) ABSTRACT

Knowledge database collation by a quantum computer is enabled. A plurality of sentences is acquired, a graph Laplacian obtained by converting a logical relationship between propositions based on the propositions of the sentences is acquired, and a quantum encoding instruction for applying the graph Laplacian to a unitary matrix is output to the quantum computer.

### CROSS REFERENCE TO RELATED APPLICATIONS

This application is a national stage of PCT Application No. PCT/JP2024/024476, having a filing date of Jul. 5, 2024, which is based on JP Application No. 2023-128856, having a filing date of Aug. 7, 2023, the entire contents both of which are hereby incorporated by reference.

### FIELD OF TECHNOLOGY

The following relates to an information processing system and an information processing method for constructing a knowledge database suitable for processing by a quantum computer.

### BACKGROUND

The knowledge database (knowledge base) is a database constructed for the purpose of improving data searchability and utilization by aggregating work experiences, know-how, and the like at one place. In the knowledge database, various techniques have been proposed in which a database is formed on the basis of a relationship between pieces of knowledge, and the relationship is searched by computer processing.

Patent Literature 1 discloses a fuzzy inference technique for learning an inference rule necessary for the fuzzy inference and performing the fuzzy inference based on a learning result. Patent Literature 1 discloses that learning a causal relationship between pieces of knowledge information as a fuzzy inference rule enables acquisition of an inference rule from knowledge information including ambiguity in a few minutes or less, and the use of the truth value and effectiveness enables execution of the fuzzy inference.

### CITATION LIST

### Patent Literature

Patent Literature 1: JP H06-202870 A

### Non Patent Literature

Non Patent Literature 1: George Siopsis (2018). “Quantum topological data analysis with continuous variables”
Non Patent Literature 2: Ankit Khandelwal and M Girish Chandra (2023). “Quantum-Enhanced Topological Data Analysis: A Peep from an Implementation Perspective”

As described above, the database search including the connection between pieces of knowledge has a problem that it takes time to perform the computer processing. In particular, in recent years, the amount of information is increasing, and the relationship therebetween tends to be complicated.

A quantum computer can exhibit superior computational power to that of a classical computer by an algorithm that uses the features of quantum computation. In exhibiting superior computational power by a quantum computer, quantum encoding and conversion of information to be computed are problems.

Embodiments of the present invention have been made in view of the above-described problems, and an aspect relates to a technique that enables knowledge database collation by quantum encoding that can be computed by a quantum computer. In addition, an aspect relates to a technique for generating a quantum circuit superior in search of a knowledge database using quantum encoding.

In order to solve the above-described problems, embodiments of the present invention includes a sentence acquisition unit, a conversion unit, and an instruction unit, the sentence acquisition unit acquires a plurality of sentences, the conversion unit acquires a graph Laplacian obtained by converting a logical relationship between propositions based on the propositions of the sentences, and the instruction unit outputs a quantum encoding instruction for applying the graph Laplacian to a unitary matrix to the quantum computer.

With such a configuration, the sentences can be converted into information that can be computed by the quantum computer.

In a desired mode of embodiments of the present invention, a collation unit that acquires an eigenvalue from the quantum computer as a quantum computation result with respect to the quantum encoding instruction, and determines presence or absence of a logical relationship from the eigenvalue is provided.

With such a configuration, the eigenvalue can be computed at high speed by the quantum computer, and based on the result, the presence or absence of the logical relationship of the target sentences can be determined.

In a desired mode of embodiments of the present invention, a knowledge database that stores information necessary for the quantum encoding instruction is provided, and the collation unit collates a sentence to be collated with information necessary for the quantum encoding instruction including graph data or graph Laplacian, and outputs the quantum encoding instruction using the information necessary for the quantum encoding that is a collation result.

With such a configuration, the quantum encoding instruction can be performed using the information necessary for the quantum encoding corresponding to the sentence to be collated.

In a desired mode of embodiments of the present invention, the conversion unit includes an analysis unit that maps sentence vectors obtained by vectorizing the sentences as point cloud data, and outputs, as an analysis result, identity between the sentence vectors connected by a change in radius of each point, and a graph conversion unit that generates the graph Laplacian based on the sentence vectors and the analysis result.

In a desired mode of embodiments of the present invention, a collation unit that acquires an eigenvalue as a quantum computation result with respect to the quantum encoding instruction, and determines that there is no logical connection when the Betti number of a 0-dimensional homology group is not 1 from the eigenvalue is provided.

With such a configuration, it is possible to adjust a range of ambiguity of a meaning of a accumulated proposition by geometric analysis. In addition, in a case where it can be analyzed that there is no geometric connection from the Betti numbers, it is determined that there is no connection of logical relationship of the sentences, and thus, it is not necessary to perform a further calculation of the logical relationship, so that the calculation cost can be reduced.

In a desired mode of embodiments of the present invention, a circuit generation unit that generates a quantum circuit that processes the quantum-encoded information based on a gene tree that is a multiway tree is provided, and the circuit generation unit generates a quantum circuit based on constraint conditions for generating a gene tree including a parent node including a unitary gate, and a child node of a quantum bit, a unitary gate for a single quantum bit, or a unitary gate including one or more control bits.

In a desired mode of embodiments of the present invention, the circuit generation unit generates a quantum circuit based on constraint conditions for generating a gene tree in which nodes excluding a terminal node are unitary gates.

In a desired mode of embodiments of the present invention, the circuit generation unit evaluates the generated quantum circuit by using an evaluation function that highly evaluates a quantum circuit including a small number of nodes.

With such a configuration, it is possible to generate a quantum circuit suitable for processing of a quantum-encoded sentence.

According to embodiments of the present invention, it is possible to provide a technique that enables knowledge database collation by a quantum computer.

### BRIEF DESCRIPTION

Some of the embodiments will be described in detail, with references to the following Figures, wherein like designations denote like members, wherein:

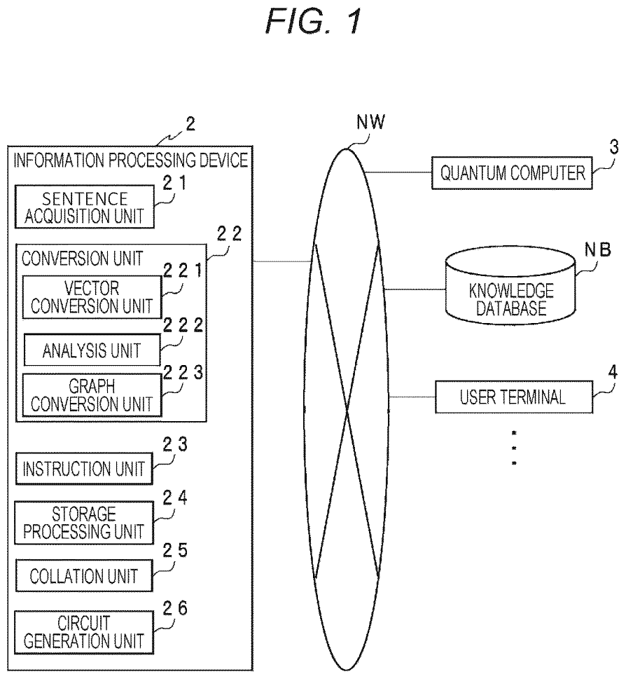

FIG. 1 shows a block diagram of a system of the present embodiment;

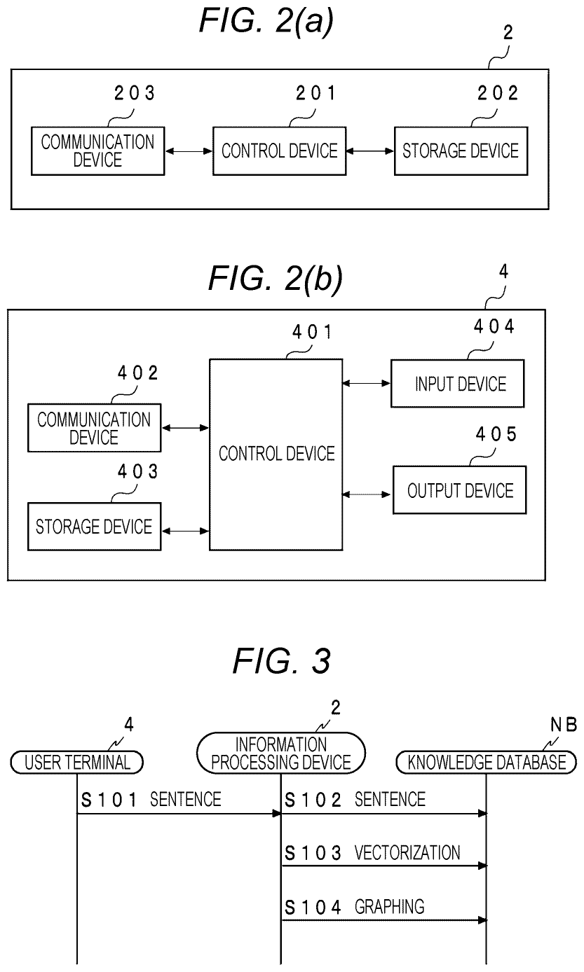

FIG. 2a shows a hardware configuration diagram of the present embodiment;

FIG. 2b illustrates a hardware configuration diagram of the user terminal;

FIG. 3 shows a processing sequence regarding knowledge database construction of the present embodiment;

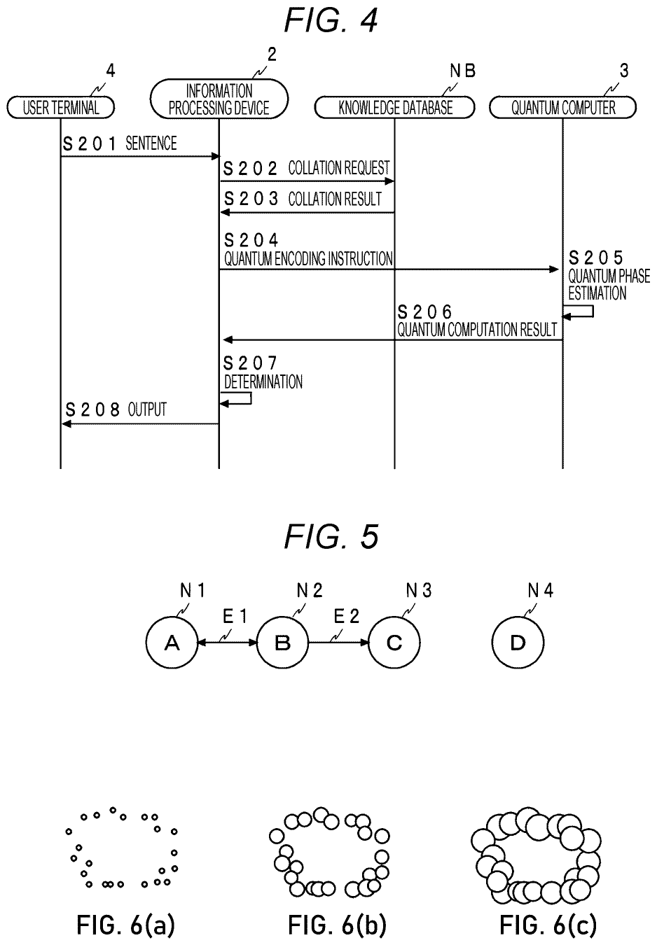

FIG. 4 shows a processing sequence regarding knowledge database collation of the present embodiment;

FIG. 5 shows a schematic diagram of a logical relationship of sentences of the present embodiment;

FIG. 6(a) shows a schematic explanatory diagram of persistent homology;

FIG. 6(b) illustrates a process of expanding each point of the point cloud data;

FIG. 6(c) illustrates a process by further expanding each point of the point cloud data;

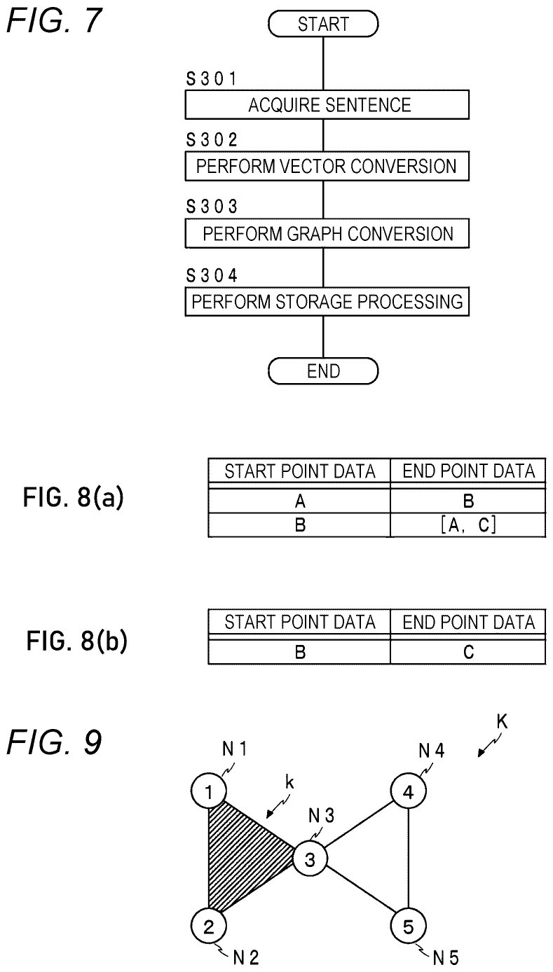

FIG. 7 shows a processing flowchart regarding knowledge database construction of the present embodiment;

FIG. 8(a) shows a configuration example of graph data of the present embodiment;

FIG. 8(b) shows a configuration example of graph data of the present embodiment;

FIG. 9 shows a schematic diagram of graph data of nodes and edges;

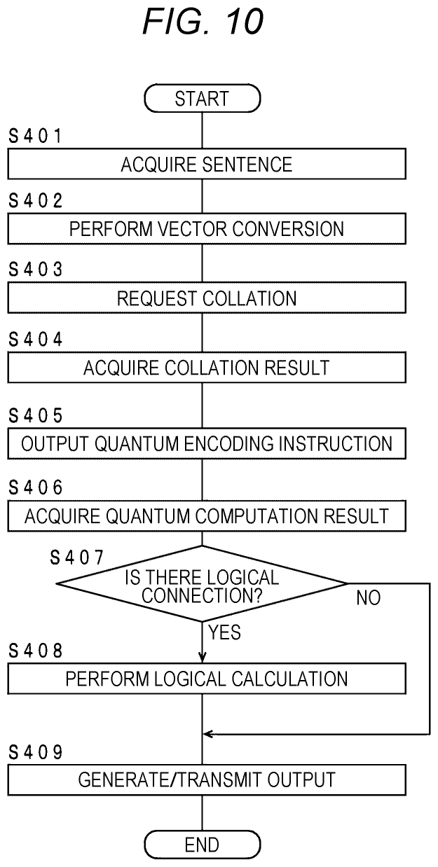

FIG. 10 shows a processing flowchart regarding knowledge database collation of the present embodiment;

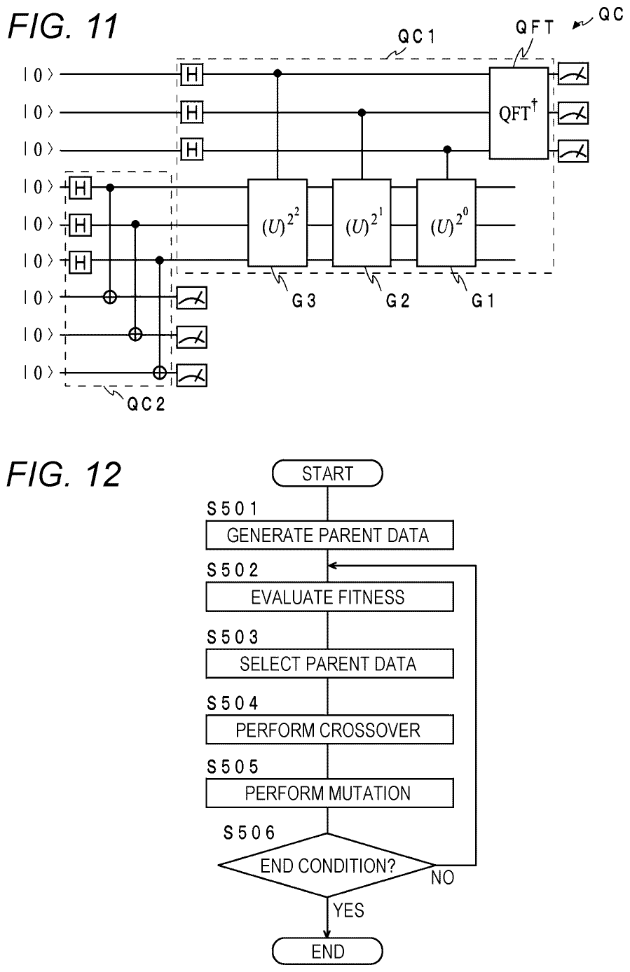

FIG. 11 shows a configuration example of a quantum circuit including a control unitary gate of the present embodiment; and

FIG. 12 shows a processing flowchart regarding quantum circuit generation of the present embodiment.

### DETAILED DESCRIPTION

Hereinafter, an information processing system according to an embodiment of the present invention will be described with reference to the drawings. Note that an embodiment described below is an example of the present invention, and the present invention is not limited to the embodiment described below, and various configurations can be adopted.

In the present embodiment, the configuration, operation, and the like of an information processing system, an information processing device, and an information processing program will be described, and a method having a similar configuration, a program of a computer, a program recording medium recording the program, and the like also have a similar function and effect. By using this program recording medium, for example, the program can be installed in a computer. A series of processing according to the present embodiment described below is provided as a computer-executable program, and can be provided via a non-transitory computer-readable recording medium such as a CD-ROM or a flexible disk, and further via a communication line.

The information processing system includes a computer device. The computer device includes an arithmetic device such as a central processing unit (CPU) and a storage device. The computer device can cause the computer device to function as the information processing device by executing the information processing program stored in the storage device using the arithmetic device. The information processing method is implemented by processing of the computer device including the information processing device.

In the present embodiment, a sentence is interpreted as a proposition. Sentences have a logical relationship based on the propositions. The propositions are, for example, “A is B”, “C is A”, and the like. A logical relationship “C is B” is derived based on such propositions. By performing quantum encoding on data representing the logical relationship of such propositions, high-speed quantum computation by a quantum computer is implemented.

FIG. 1 illustrates a block diagram of an information processing system 1. The information processing system 1 includes an information processing device 2, a quantum computer 3, a user terminal 4, and a knowledge database NB, which are communicably connected. Although only one user terminal 4 is illustrated in FIG. 1, a plurality of user terminals 4 may be provided. The quantum computer 3 may be configured to be mounted on the information processing device 2.

The information processing device 2 includes, as functional components, a sentence acquisition unit 21, a conversion unit 22, an instruction unit 23, a storage processing unit 24, a collation unit 25, and a circuit generation unit 26. In addition, the conversion unit 22 includes a vector conversion unit 221, an analysis unit 222, and a graph conversion unit 223.

In the present embodiment, the quantum computer 3 configures a quantum bit by any hardware (for example, a superconducting quantum circuit or a light quantum circuit), and performs quantum computation by performing quantum gate operation on the quantum bit. The quantum computer 3 performs quantum computation based on the quantum circuit.

The user terminal 4 receives an input of a sentence to be accumulated in the knowledge database NB and a sentence to be collated in the knowledge database NB. The user terminal 4 can construct the knowledge database NB by accumulating sentences by transmitting the sentences to the information processing device 2. The user terminal 4 can refer to the collation result by transmitting the sentences to be collated to the information processing device 2. Note that, in the present embodiment, it is assumed that the sentences are processed as computer-processable text data.

FIG. 2(a) illustrates a hardware configuration diagram of the information processing device 2. The information processing device 2 includes, as a hardware configuration, a control device 201, a storage device 202, and a communication device 203. In the present embodiment, the information processing device 2 can use a computer device such as a server device or a personal computer. Note that the information processing device 2 is only required to include a plurality of computer devices and to be able to implement the functional components (21 to 26) as a whole, and is not limited to the configuration illustrated in FIG. 2(a).

The control device 201 includes one or more processors such as a CPU and a graphics processing unit (GPU), and executes an information processing program, an operating system (OS), and other applications to control overall processing in the information processing device 2. The storage device 202 is a hard disk drive (HDD), a solid state drive (SSD), flash memory, random access memory (RAM), or the like, and stores an information processing program and various data. The communication device 203 controls communication with a communication network and implements data communication with the user terminal 4, the quantum computer 3, and the like.

FIG. 2(b) illustrates a hardware configuration diagram of the user terminal 4. The user terminal 4 includes, as a hardware configuration, a control device 401, a storage device 402, a communication device 403, an input device 404, and an output device 405. In the present embodiment, a smartphone, a personal computer, a tablet terminal, or the like can be used as the user terminal 4.

The control device 401 includes one or more processors such as CPUs, and executes a terminal program, an OS, other applications, and the like to control overall processing in the user terminal 4. The storage device 402 is an HDD, an SSD, flash memory, RAM, or the like, and stores a browser application and various data. The communication device 403 controls communication with a communication network and implements data communication at least with the information processing device 2. The input device 404 is an input interface that receives an input operation by a user, and includes a microphone, a touch panel, a mouse, a keyboard, and the like. The output device 405 includes a display or the like that performs display output.

### <Knowledge Database Construction>

FIG. 3 illustrates a processing sequence of the information processing system 1 in steps of constructing a knowledge database.

The user terminal 4 transmits a sentence to the information processing device 2 (S101). The information processing device 2 stores the sentence received from the user terminal 4 in the knowledge database NB (S102). In addition, the information processing device 2 stores a sentence vector obtained by vectorizing the sentence received from the user terminal 4 in the knowledge database NB (S103). In addition, the information processing device 2 stores graph data obtained by graphing the sentence received from the user terminal 4 and/or graph Laplacian in the knowledge database NB (S104).

### <Knowledge Database Collation>

FIG. 4 illustrates a processing sequence of the information processing system 1 in steps of collating the knowledge database constructed by the steps of constructing the knowledge database. In the present embodiment, in the collation of the knowledge database, when the user inputs a sentence to be collated (target sentence), the target sentence is interpreted as a proposition, and the collation is performed on the basis of the sentence stored in the knowledge database NB, wherein the true/false determination result of the proposition can be obtained. Note that, similarly to a conventional knowledge database, it is naturally possible to search and browse a sentence using any search query or the like.

The user terminal 4 transmits the collation target sentence to the information processing device 2 (S201). The information processing device 2 vectorizes the received sentence and then transmits a collation request to the knowledge database NB (S202). Note that the information processing device 2 may store the received sentence or the sentence vector in the knowledge database NB. The information processing device 2 receives the collation result as graph data or graph Laplacian (S203). Note that when the information processing device 2 cannot acquire the corresponding collation result, the information processing device 2 outputs a result indicating that the collation could not be performed to the user terminal 4. In addition, it is assumed that the information processing device 2 performs conversion into a graph Laplacian in a case where graph data is acquired as a collation result. The information processing device 2 outputs a quantum encoding instruction for applying the graph Laplacian to a unitary matrix to the quantum computer 3 (S204). The quantum computer 3 performs computation of quantum phase estimation according to the quantum encoding instruction (S205). The information processing device 2 receives the quantum computation result of the quantum phase estimation with respect to the quantum encoding instruction (S206). The information processing device 2 performs collation determination regarding the quantum phase estimation result (S207). The information processing device 2 transmits an output based on the collation determination result to the user terminal 4 (S208). Here, the output based on the collation determination includes the true/false result of the proposition. The true/false result of the proposition is that the proposition is logically connected and true, the proposition is logically connected but false, there is no logical connection and there is a high possibility of being false, or it is regarded as false and the like.

In the present embodiment, the sentence is represented as a knowledge graph. The sentence is treated as a node. The logical relationship between sentences is treated as an edge. Specifically, the edge represents AND, OR, NOT, IMP(→), and the like, which are logical operators.

FIG. 5 illustrates a schematic diagram of a logical relationship between sentences according to the present embodiment. In FIG. 5, it is assumed that sentence A, sentence B, and sentence C have a logical relationship of “A AND B⇒C”. The sentences A to C are represented as nodes N1 to N3, respectively. An edge E1 represents a logical relationship of AND. An edge E2 represents a logical relationship of the conclusion. Here, since an node N4 of a sentence D is not connected to the sentences A to C by edges, the node N4 is treated as not having a logical relationship.

The logical relationship between the sentence and the sentence and of the sentence can be expressed by a sentence vector obtained by vectorizing the sentences. The vectorization of the sentence can use an existing natural language processing model, and the sentence vector is output by inputting the sentence into the natural language processing model. The sentence vector is a multi-dimensional vector, and similar sentences have similar vectors and thus are mapped onto a close vector space. In addition, a plurality of sentence vectors having a logical relationship between the sentences is mapped on a relatively close vector space corresponding to the logical relationship. For example, a logical relationship between similar sentence vectors can be an inclusion relationship IMP.

In a case where a proposition included in one sentence is similar to a proposition included in the other sentence, a scene is assumed in which these propositions are interpreted to be the same. In addition, regarding the logical relationship between sentences, a scene is assumed in which it is desirable to interpret propositions having no logical relationship in the past as having a logical relationship by broadly interpreting similar propositions.

In the present embodiment, a geometric analysis method is adopted in order to give a broad range of interpretation to the propositions of sentences. More specifically, the sentence vector is interpreted by an analysis method to which persistent homology is applied. For a detailed description of the persistent homology, see Non Patent Literature 1. In the analysis method based on persistent homology, for example, an nth-order homology group can be considered for a vector space. According to this analysis, information such as the number of connected components in the vector space is obtained from the 0th-order homology group, the number of one-dimensional holes (rings) in the vector space is obtained from the 1st-order homology group, and the number of two-dimensional holes (cavities) in the vector space is obtained from the 2nd-order homology group. The information obtained by these geometric analyses is called Betti numbers. Betti numbers are used for analysis in which structures that are considered to be identical by continuous deformation are classified as identical.

The analysis method of the present embodiment is applied to the interpretation of the logical relationship between the sentence vectors mapped in the vector space on the basis of the Betti numbers. Specifically, a 0-dimensional Betti number represents the number of connected components, and when the 0-dimensional Betti number is 1, it can be analyzed that the number of structurally connected components of an analysis target is one. That is, it can be analyzed that there is a possibility that the analysis target has a series of connections as a logical relationship. On the other hand, when the 0-dimensional Betti number is 2 or more, the analysis target is divided in terms of the logical relationship and can be analyzed as having no connection. Therefore, it is possible to determine the presence or absence of a logical relationship by acquiring the 0-dimensional Betti number.

FIGS. 6(a)-(c) are a schematic explanatory diagram of persistent homology. Here, it is assumed that the sentence vectors are mapped as points in the vector space. That is, the sentence vectors are regarded as point cloud data in the vector space.

FIG. 6(a) illustrates point cloud data corresponding to the sentence vectors mapped on the vector space. In the persistent homology, each point of the point cloud is gradually expanded. FIG. 6(b) illustrates a process of expanding each point of the point cloud data. Here, it is interpreted that the number of connected components is reduced as a result of connection of some points. In FIG. 6(c), by further expanding each point of the point cloud data, all the points are connected to form a torus. As illustrated in FIGS. 6(a) to 6(c), by expanding each point, the number of holes finally becomes one as a result of the formation of a torus, and the Betti numbers change. It is understood that, with the change in the Betti numbers, the interpretations of the propositions of the sentences and the logical relationship between the sentences also change, and the range of ambiguity of the meaning of the sentence can be adjusted.

FIG. 7 illustrates a flowchart of detailed processing of constructing the knowledge database NB in the information processing device 2.

The sentence acquisition unit 21 acquires a sentence related to the knowledge accumulated in the knowledge database NB from the user terminal 4 (S301).

The vector conversion unit 221 converts the acquired sentence into a sentence vector and maps the sentence vector in the vector space (S302). The sentence vector mapped to the vector space is called distributed representation. It is assumed that the distributed representation is stored in the knowledge database NB.

The analysis unit 222 determines the similarity between the sentence vectors. In the present embodiment, the similarity of the sentence vectors is determined by cosine similarity. In cosine similarity, two sentence vectors are normalized with a value ranging from −1 to 1. When the cosine similarity is 1, the angle between the sentence vectors is 0 degrees, and it is determined that the similarity between the sentence vectors is high. When the cosine similarity is −1, the angle between the sentence vectors is 180 degrees, and it is determined that the similarity between the sentence vectors is low. Note that the determination of the similarity between the sentence vectors is not limited to the determination based on the cosine similarity, and methods such as Euclidean distance and KL divergence can be adopted.

As in the analysis method described above, the analysis unit 222 expands each point by a radius r using the sentence vectors mapped in the vector space as the point cloud data. Here, the radius r is defined as a numerical value used for adjusting the similarity of the sentences described above, and can be optionally set depending on how much the range of the interpretation of the sentence is widened. For example, in a case where there are two similar propositions that are targets to be considered to be the same, the radius r at which the points of sentence vectors corresponding to the propositions are connected on the vector space is set. When the radius r is zero, only the identity of only the strictly matching sentences is allowed, and when the distance between the sentence vectors is a certain level or more (this number is set as the radius r), it is possible to equate the sentences including ambiguity of the meaning.

In the present embodiment, the radius r is set as a constant, but any radius r may be set via the user terminal 4. In addition, when the collation result with respect to the collation request cannot be acquired, the radius r can be set to a larger value and a collation request can be made again. As the radius r, a different constant may be set according to the attribute or usage of the knowledge stored in the knowledge database NB.

The analysis unit 222 can use, as an analysis result, the Betti numbers that are changed by adjustment of the radius r. The Betti numbers represent a geometric feature of a structure by a point cloud constituting the point cloud data. The analysis unit 222 can use the identity of the propositions as an analysis result by a geometric change in point cloud data. The graph conversion unit 223 performs graph conversion of graphing a logical relationship between propositions on the basis of the propositions of the sentences (S303). Specifically, the graph conversion unit 223 generates graph data on the basis of the sentence vectors mapped in the vector space. In addition, the graph conversion unit 223 further converts the graph data to generate a graph Laplacian. Here, the graph conversion unit 223 can generate graph data using the analysis result of the analysis unit 222 with two similar propositions as the same proposition.

In the present embodiment, the graph data includes start point data and end point data. FIG. 8(a) illustrates a configuration example of graph data. The logical connection of propositions A to C has, for example, a logical relationship of “A≈B” and a logical relationship of “B is C”. When the proposition A is set as the start point data, the first row of the graph data has the proposition A as the start point data and the proposition B as the end point data. When the proposition B is set as the start point data, the second row of the graph data has the proposition B as the start point data and the propositions A and C as the end point data. Note that, since the logical relationship of “B is C” does not hold the opposite logical relationship, the row of the graph data having the proposition C as the start point data is not generated.

In a case where the graph conversion unit 223 can acquire an analysis result indicating that the similar propositions A and B are the same proposition, the graph conversion unit 223 can have the graph data illustrated in FIG. 8(b). In FIG. 8, the first row of the graph data has the proposition B as the start point data and the proposition C as the end point data, and illustrates a logical relationship of “B is C”. Here, since the propositions A and B are regarded as the same proposition, there is no graph data of the first row of FIG. 8(a). As illustrated in FIG. 8(b), since there is the analysis result by the analysis unit 222, the graph conversion unit 223 can generate graph data equivalent to that in FIG. 8(a) even when there are no sentence vectors indicating the logical relationship of “A≈B”. As a result, even when the number of sentences stored in the knowledge database NB is small, it is possible to perform collation by broadly interpreting the propositions.

Quantum encoding of data represented by nodes and edges will be described with reference to Non Patent Literature 2. Here, data that can be represented by nodes and edges illustrated in FIG. 9 is considered. In the present embodiment, these pieces of data correspond to graph data. Referring to FIG. 9, target data includes nodes N1 to N5, and the nodes N1 to N3 constitute a substructure k. The whole structure K is represented by Formula (1).

[Math. 1]

K={{1},{2},{3},{4},{5},{1,2},{1,3},{2,3},{1,2,3},{3,4},{3,5},{4,5}} (1)

Formulae (2) and (3) represent a two-dimensional single boundary operator 82 of the structure. Each column of a one-dimensional single boundary operator ∂1 represents the relationship between the nodes N1 to N5, and for example, the first column represents the relationship between the nodes N1 and N2. The two-dimensional single boundary operator ∂2 represents the substructure k.

$$\begin{matrix}[ Math . 2 ] & \\ \text{?} = [ \begin{matrix}1 & 1 & 0 & 0 & 0 & 0 \\ - 1 & 0 & 1 & 0 & 0 & 0 \\ 0 & - 1 & - 1 & 1 & 1 & 0 \\ 0 & 0 & 0 & - 1 & 0 & 1 \\ 0 & 0 & 0 & 0 & - 1 & - 1\end{matrix} ] & ( 2 )\end{matrix}$$

$$\begin{matrix}[ Math . 3 ] & \\ \text{?} = [ \begin{matrix}1 \\ - 1 \\ 1 \\ 0 \\ 0 \\ 0\end{matrix} ] & ( 3 )\end{matrix}$$

$$\text{?} \text{indicates text missing or illegible when filed}$$

From these boundary operators, a graph Laplacian Δ1 represented by Formula (4) is obtained.

$$\begin{matrix}[ Math . 4 ] & \\ \text{?} = \text{?} \\ = [ \begin{matrix}3 & 0 & 0 & 0 & 0 & 0 \\ 0 & 3 & 0 & - 1 & - 1 & 0 \\ 0 & 0 & 3 & - 1 & - 1 & 0 \\ 0 & - 1 & - 1 & 2 & 1 & - 1 \\ 0 & - 1 & - 1 & 1 & 2 & 1 \\ 0 & 0 & 0 & - 1 & 1 & 2\end{matrix} ] & ( 4 )\end{matrix}$$

$$\text{?} \text{indicates text missing or illegible when filed}$$

The graph Laplacian Δ1 is padded to have a data length necessary for quantum computation. Here, since the graph Laplacian Δ1 is a 6×6 matrix, it is padded to an 8×8 matrix that is a power of 2. Note that padding corresponding to the matrix size of the target data is appropriately performed. A padded graph Laplacian Δ1′ is represented by Formula (5).

$$\begin{matrix}[ Math . 5 ] & \\ \text{?} = [ \begin{matrix}3 & 0 & 0 & 0 & 0 & 0 & 0 & 0 \\ 0 & 3 & 0 & - 1 & - 1 & 0 & 0 & 0 \\ 0 & 0 & 3 & - 1 & - 1 & 0 & 0 & 0 \\ 0 & - 1 & - 1 & 2 & 1 & - 1 & 0 & 0 \\ 0 & - 1 & - 1 & 1 & 2 & 1 & 0 & 0 \\ 0 & 0 & 0 & - 1 & 1 & 2 & 0 & 0 \\ 0 & 0 & 0 & 0 & 0 & 0 & 3 & 0 \\ 0 & 0 & 0 & 0 & 0 & 0 & 0 & 3\end{matrix} ] & ( 5 )\end{matrix}$$

$$\text{?} \text{indicates text missing or illegible when filed}$$

The graph Laplacian Δ1 is a Hermitian matrix. The dimension of the eigenspace of the zero eigenvalue in the Hermitian matrix is a Betti number. The zero eigenvalue is a kernel dimension of a matrix and has a multiplicity in which an eigenvalue of the matrix is 0. In Formula (5), the zero eigenvalue is 1, and a one-dimensional Betti number obtained in this example is 1. However, in general, the larger the dimension of the matrix, the more difficult the computation. The quantum computer can obtain the eigenvalue at high speed by a quantum phase estimation algorithm.

Next, the graph Laplacian Δ1 is converted into a Hermitian matrix H that is a linear combination of tensor products of Pauli operators represented by Formula (6).

[Math. 6]

H^{ε}=−0.5 XXI −0.5 YYI −0.5 ZIX −0.25 IXI −0.25 XIX

−0.25 XYY −0.25 XZX −0.25 YTY −0.25 YZY −0.25 ZXI

−0.125 IZI −0.125 IZZ −0.125 ZZZ +0.125 IIZ +0.125 ZII

+0.125 ZIZ+0.25 IXZ+0.25 XXX+0.25 YXY+0.25 YXX

+0.25 ZXZ+0.376 ZZI+0.5 IZX+2.625 III (6)

By using the Hermitian matrix H, a unitary matrix U represented by Formula (7) can be expressed. In this transformation, since the kernel dimension information of the Hermitian matrix is stored, an eigenvalue, that is, the Betti number can be derived by obtaining the kernel dimension of the unitary matrix. In the quantum computer, an eigenvalue estimation algorithm (also referred to as a phase estimation algorithm) that is fast with respect to the unitary matrix U is known, and this enables high-speed computation by the quantum computer by converting target data into the unitary matrix. In the control unitary gate of the quantum circuit, a control unitary operator U is arranged. In the quantum circuit, a plurality of power gates of the control unitary gate is arranged.

[Math. 7]

U^{ε}=e^{iH}^{_{ε}} (7)

As described above, the graph conversion unit 223 can further convert the graph data into the graph Laplacian to graph the sentence and generate information necessary for quantum encoding by the quantum computer 3.

The storage processing unit 24 stores the information necessary for quantum encoding in the knowledge database NB (S304). The information necessary for quantum encoding is graph data or graph Laplacian. The knowledge database NB stores at least a sentence, and a sentence vector and graph data corresponding to the sentence. The knowledge database NB further stores a corresponding graph Laplacian. The knowledge database NB stores graph data or graph Laplacian as a collation result with respect to a collation request based on a sentence or a sentence vector as a collation target. In the present embodiment, when the graph data can be acquired as the collation result, then the graph Laplacian can be generated, and the quantum encoding instruction can be output, but by acquiring the graph Laplacian as the collation result, it is possible to omit the processing of converting the graph data into the graph Laplacian in the collation stage, which is more desirable.

As one aspect, the vector conversion unit 221 generates a sentence vector by performing vectorization processing on the sentence stored in the knowledge database NB. In addition, the graph conversion unit 223 generates graph data by performing graphing processing on the sentence vector stored in the knowledge database NB. In addition, the instruction unit 23 generates the graph Laplacian from the graph data stored in the knowledge database NB, and causes the quantum computer 3 to process quantum encoding based on the graph Laplacian, thereby generating quantum-encoded information. The timing of each piece of data processing is not limited to the timing at which a new sentence is acquired, and the processing may be appropriately executed at the timing at which certain data is accumulated in the knowledge database NB. As a result, the logical relationship between sentences can be updated at any timing.

FIG. 10 illustrates a flowchart of detailed processing of collation of the knowledge database NB in the information processing device 2.

First, the sentence acquisition unit 21 acquires a target sentence to be collated via the user terminal 4 (S401). In the present embodiment, the target sentence is input with information that the user wants to know true/false as a sentence. For example, in a case where the knowledge database NB accumulates knowledge related to office work, by inputting the office work true/false of which is unknown as a sentence, a collation result indicating whether or not it is correct is obtained as an output.

The vector conversion unit 221 converts the target sentence into the sentence vector (target sentence vector) (S402). The collation unit 25 makes a collation request to the knowledge database NB with respect to the converted target sentence vector (S403).

The analysis unit 222 may use the target sentence vector as point cloud data on the persistent homology, and may execute analysis processing of expanding each point by an inverse r of the distance between the vectors for ambiguity of the meaning. The analysis unit 222 may receive an instruction input regarding the abstraction level of the interpretation of the proposition via the user terminal 4. The analysis unit 222 determines the radius r of the point cloud data according to the abstraction level regarding which the instruction input is performed.

The collation unit 25 acquires a collation result from the knowledge database NB (S404). The collation result is graph data or graph Laplacian of the sentence vector corresponding to the target sentence vector stored in the knowledge database NB. In a case where graph data is acquired as the collation result, the graph conversion unit 223 converts the acquired graph data into the graph Laplacian.

The instruction unit 23 outputs a quantum encoding instruction to the quantum computer 3 based on the acquired graph Laplacian (S405). Specifically, the instruction unit 23 generates a quantum encoding instruction for applying the graph Laplacian to the unitary matrix. The quantum computer 3 can perform quantum phase estimation according to the quantum encoding instruction.

The quantum computer 3 performs quantum phase estimation from the quantum encoding instruction of the collation target, and transmits a computation result to the information processing device 2. The computation result is an eigenvalue of a quantum-encoded unitary matrix.

The collation unit 25 acquires the computation result including the eigenvalue of the unitary matrix from the quantum computer 3 (S406).

The collation unit 25 determines the presence or absence of a logical relationship from the eigenvalue (S407). Specifically, the collation unit 25 acquires the 0-dimensional Betti number from the eigenvalue, determines that there is logical connection when the 0-dimensional Betti number is 1 (YES in S407), and performs logical calculation in subsequent S408. When the 0-dimensional Betti number is 2 or more, the collation unit 25 determines that there is no logical connection (NO in S407), and the logical calculation can be omitted. Although the logical calculation by a classical computer requires a calculation cost, since the collation target having no logical relationship can be excluded from the logical calculation by the quantum phase estimation by the quantum computer 3, the calculation cost can be reduced.

The collation unit 25 performs logical calculation on the collation target determined to be logically connected (S408). The logical calculation is executed by referring to a logical relationship such as graph data of a collation result. The collation unit 25 outputs a true/false determination result of the proposition of the sentence as a collation target as a result of the logical calculation. The false of the true/false determination result is a result indicating that there is no logical relationship, but a result may be output separately from the determination result of no logical connection in S407. The determination result of no logical connection in S407 technically indicates a result estimating that it is highly likely to be false or it is false since there is no logical connection without asking true/false.

The collation unit 25 generates an output based on the computation result and transmits the output to the user terminal 4 (S409). The output based on the collation result includes information indicating the presence or absence of a logical connection of the target sentences. In addition, the output based on the collation result may include a sentence that forms a logical connection with the true/false determination result when the sentence is used as a proposition from the information stored in the knowledge database NB in a case where there is a logical relationship. As a result, the user can effectively utilize the accumulated knowledge by referring to the sentence serving as the basis.

### <Quantum Circuit Generation>

In the present embodiment, the quantum circuit constituting the quantum computer 3 includes a control unitary gate. FIG. 11 illustrates an example of a configuration diagram of a quantum circuit QC including the control unitary gate. The quantum circuit QC includes a quantum phase estimation circuit QC1 and a quantum superposition state preparation circuit QC2. The quantum circuit QC includes a Hadamard gate, a measurement, and quantum gates such as control unitary gates G1 to G3.

In the present embodiment, the quantum phase estimation circuit QC1 is used for calculation of quantum phase estimation. In embodiments, the control unitary gates G1 to G3 are quantum gates used for calculation of quantum phase estimation, and affect the speed of quantum computation and the like.

Although the quantum phase estimation circuit QC1 illustrated in FIG. 11 is simplified, the actual quantum circuit is long. Therefore, it is desirable that the quantum circuit is made efficient by a circuit as short as possible and efficient arrangement of quantum gates.

The circuit generation unit 26 generates a quantum circuit that processes the quantum phase estimation. The circuit generation unit 26 generates a quantum circuit by generating a gene tree on the basis of a genetic algorithm.

FIG. 11 illustrates a processing flowchart related to quantum circuit generation. The circuit generation unit 26 generates a quantum circuit based on a genetic algorithm according to the processing flowchart illustrated in FIG. 12.

First, the circuit generation unit 26 randomly generates parent quantum circuit data (S501). The circuit generation unit 26 evaluates the fitness of the quantum circuit data, which is the gene tree generated by an evaluation function (S502). The circuit generation unit 26 selects the parent quantum circuit data evaluated as the high fitness (S503). The circuit generation unit 26 arbitrarily takes two pieces of quantum circuit data generated as gene trees at a constant rate and partially exchanges nodes to generate quantum circuit data (S504). The circuit generation unit 26 arbitrarily takes one piece of quantum circuit data generated as a gene tree at a constant rate, and replaces one node with a randomly selected node to generate quantum circuit data (S505). When determining that an end condition is not satisfied (NO in S506), the circuit generation unit 26 returns to S502 and repeatedly executes the processing. When determining that the end condition is satisfied (YES in S506), the circuit generation unit 26 ends the processing. The quantum phase estimation circuit QC1 is designed based on the generated quantum circuit data.

The constraint conditions of the gene algorithm in the present embodiment will be described. The gene tree is a multiway tree, and includes child nodes branching from a parent node serving as a parent. The node is one quantum bit gate or an nth quantum bit. The terminal node is a quantum bit. A quantum bit gate that handles a plurality of quantum bits is a control unitary gate. When the control unitary gate is a parent node, the child node is a plurality of quantum bits. When the parent node is a quantum gate, the quantum gate processes the quantum bits of the child node. The nodes excluding the terminal node are unitary gates. The unitary gate is a gate capable of performing quantum phase estimation calculation in the present embodiment. The control unitary gate refers to a unitary gate that handles a plurality of input signals.

The evaluation function in the present embodiment has the features described below. The evaluation function evaluates the difference between a measurement result to be obtained and an obtained measurement result when the superposition of possible quantum states with respect to the basis vector of Pauli Strings is given as an input, and evaluates that the closer to 0, the higher the fitness of the gene tree. L1 norm, L2 norm, and the like can be adopted for the difference calculation, and the L2 norm is particularly suitable. The evaluation function evaluates that the smaller the number of nodes, the higher the fitness of the gene tree because the genetic algorithm is converged to the shortest possible circuit. The evaluation function evaluates that the closer the distance between the quantum bit to be controlled and the quantum gate that controls the quantum bit is, the higher the fitness of the gene tree, because the genetic algorithm is converged to the arrangement that promotes the interaction between the quantum bits as close to each other as possible. In a case where the gene tree has a plurality of quantum bits as child nodes, and in a case where the gene tree has the same quantum bit as a child node, the evaluation function evaluates that it is a gene tree having a low fitness. The evaluation function evaluates that it is a gene tree having a high fitness as the number of T gates having a high cost is small.

In the present embodiment, the circuit generation unit 26 can generate quantum circuit data to which the genetic algorithm is applied for each tensor product of a Pauli operator. The circuit generation unit 26 integrates the pieces of quantum circuit data generated for the tensor products to form a quantum circuit used for quantum encoding in which the graph Laplacian is applied to the unitary matrix. When the quantum circuit for quantum encoding is to be generated at a time based on the genetic algorithm, problems such as a case where the algorithm does not converge or a case where generation takes time occur. By adopting a method of integrating tensor product calculation circuits, the above-described problem can be solved.

The circuit generation unit 26 generates quantum circuit data by the gene tree according to the above-described constraint conditions and evaluation function. When generating the control unitary gate as a parent node, the circuit generation unit 26 generates child nodes related to quantum bits to be at least two or more input signals. At this time, two or more child nodes are generated. As a result, an efficient quantum circuit including the arrangement of the control unitary gate used for the calculation of the quantum phase estimation according to the present embodiment can be generated.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE SIGNS LIST

1 Information processing system
2 Information processing device
21 Sentence acquisition unit
22 Conversion unit
221 Vector conversion unit
222 Analysis unit
223 Graph conversion unit
23 Instruction unit
24 Storage processing unit
25 Collation unit
26 Circuit generation unit
3 Quantum computer
4 User terminal
NB Knowledge base

1. An information processing system enabling knowledge database collation using a quantum computer, the information processing system comprising:
a processor and a communication device, wherein the processor is configured to:
acquire a plurality of sentences,
acquire a graph Laplacian obtained by converting a logical relationship between propositions based on the propositions of the plurality of sentences,
map sentence vectors obtained by vectorizing the plurality of sentences as point cloud data,
output, as an analysis result, identity between the sentence vectors connected by a change in radius of each point, and
generate the graph Laplacian based on the sentence vectors and the analysis result, and
the communication device is configured to output a quantum encoding instruction for applying the graph Laplacian to a unitary matrix to the quantum computer.

2. An information processing system enabling knowledge database collation using a quantum computer, the information processing system comprising:
a processor and a communication device, wherein the processor is configured to:
acquire a plurality of sentences, and
acquire a graph Laplacian obtained by converting a logical relationship between propositions based on the propositions of the plurality of sentences,
the communication device is configured to output a quantum encoding instruction for applying the graph Laplacian to a unitary matrix to the quantum computer,
the processor is configured to generate, with respect to the quantum encoding instruction, a quantum circuit for processing quantum-encoded information based on a gene tree that is a multiway tree, and
the quantum circuit is generated based on constraint conditions for generating a gene tree including a parent node including a unitary gate, and a child node of a quantum bit, a unitary gate for a single quantum bit, or a unitary gate including one or more control bits.

3. The information processing system according to claim 1, comprising: the processor is configured to acquire an eigenvalue from the quantum computer as a quantum computation result with respect to the quantum encoding instruction, and determines presence or absence of a logical relationship from the eigenvalue.

4. The information processing system according to claim 3,
comprising: a storage device is configured to store information necessary for the quantum encoding instruction, wherein
the processor is configured to collate a sentence to be collated and information necessary for the quantum encoding instruction including graph data or graph Laplacian, and outputs the quantum encoding instruction using the information necessary for the quantum encoding instruction that is a collation result.

5. The information processing system according to claim 1, comprising: the processor acquire an eigenvalue as a quantum computation result with respect to the quantum encoding instruction, and determines that there is no logical connection when a 0-dimensional Betti number derived from the eigenvalue is not 1.

6. The information processing system according to claim 2, wherein the processor generates a quantum circuit based on constraint conditions for generating a gene tree wherein nodes excluding a terminal node are unitary gates.

7. The information processing system according to claim 2, wherein the processor evaluate the generated quantum circuit by using an evaluation function that evaluates a quantum circuit including a small number of nodes highly and closeness of arrangement of quantum bits to be interacted.

8. An information processing method enabling knowledge database collation using a quantum computer, the processing method executed by a computer having a processor and a communication device, the method comprising:
acquiring by the processor a plurality of sentences,
acquiring by the processor a graph Laplacian obtained by converting a logical relationship between propositions based on the propositions of the plurality of sentences,
wherein
acquiring the graph Laplacian by at least one of one or more processors includes,
mapping sentence vectors obtained by vectorizing a plurality of sentences as point cloud data,
outputting, as an analysis result, identity between the sentence vectors connected by a change in radius of each point
and generating the graph Laplacian based on the sentence vectors and the analysis result,
and outputting by the communication device a quantum encoding instruction for applying the graph Laplacian to a unitary matrix to the quantum computer.

9. An information processing method enabling knowledge database collation using a quantum computer, the processing method executed by a computer having a processor and a communication device, the method comprising:
acquiring by the processor a plurality of sentences,
acquiring by the processor a graph Laplacian obtained by converting a logical relationship between propositions based on the propositions of the plurality of sentences,
outputting by a communication device a quantum encoding instruction for applying the graph Laplacian to a unitary matrix to the quantum computer,
generating by the processors a quantum circuit that processes quantum-encoded information based on a gene tree that is a multiway tree with respect to the quantum encoding instruction, and
the quantum circuit is generated based on constraint conditions for generating a gene tree including a parent node including a unitary gate, and a child node of a quantum bit, a unitary gate for a single quantum bit, or a unitary gate including one or more control bits.

10. The information processing system according to claim 2, comprising: the processor is configured to acquire an eigenvalue from the quantum computer as a quantum computation result with respect to the quantum encoding instruction, and determines presence or absence of a logical relationship from the eigenvalue.
